(19) United States
(12) Patent Application Publication
(10) Pub. No.: US 2025/0348519 A1
(43) Pub. Date: Nov. 13, 2025

(54) MERGE-BASED COMPUTATION

(71) Applicant: Kyndryl, Inc., New York, NY (US)

(72) Inventor: MANISH GUPTA, New Delhi (IN)

(21) Appl. No.: 18/658,097

(22) Filed: May 8, 2024

(51) Int. Cl. G06F 16/31; G06F 16/33

(52) U.S. Cl. CPC G06F 16/316; G06F 16/3347

(57) ABSTRACT

Embodiments sort a plurality of documents in an increasing order of frequency updates, create multiple recursive partitions of the plurality of sorted documents, compute a cost of the multiple recursive partitions, choose a partition with a smallest cost from computed costs of the multiple recursive partitions, and merge the plurality of documents based on the partition with the smallest cost.

### BACKGROUND

Aspects of the present invention relate generally to merge-based computation and, more particularly, to systems and methods of merge-based computation to create a final index for documents in vector databases.

In vector databases, an update or delete operation of a document is achieved by keeping a mapping of a name of a document chunk to a respective identification. Further, the mapping of the name of the document chunk to the respective identification is maintained externally from the vector databases.

### SUMMARY

In a first aspect of the invention, there is a computer-implemented method including: sorting, by a computing device, a plurality of documents in an increasing order of frequency updates; creating, by the computing device, multiple recursive partitions of the plurality of sorted documents; computing, by the computing device, a cost of the multiple recursive partitions; choosing, by the computing device, a partition with a smallest cost from computed costs of the multiple recursive partitions; and merging, by the computing device, the plurality of documents based on the partition with the smallest cost.

In another aspect of the invention, there is a computer program product including one or more computer readable storage media having program instructions collectively stored on the one or more computer readable storage media. The program instructions are executable to: receive a plurality of documents for indexing into a vector database system; sort the plurality of documents in an increasing order of frequency updates; create multiple recursive partitions of the plurality of sorted documents; compute a cost of the multiple recursive partitions; choose a partition with a smallest cost from computed costs of the multiple recursive partitions; merge the plurality of documents based on the partition with the smallest cost; and create a final vector database which comprises the merged plurality of documents.

In another aspect of the invention, there is a system including a processor, a computer readable memory, one or more computer readable storage media, and program instructions collectively stored on the one or more computer readable storage media. The program instructions are executable to: receive a plurality of documents for indexing into a vector database system; sort the plurality of documents in an increasing order of frequency updates; create multiple recursive partitions of the plurality of sorted documents based on a Monte Carlo algorithm; compute a cost of the multiple recursive partitions; choose a partition with a smallest cost from computed costs of the multiple recursive partitions; merge the plurality of documents based on the partition with the smallest cost; and create a final vector database which comprises the merged plurality of documents.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a merge computation system in accordance with aspects of the present invention.

FIG. 5 shows an example of a first partition of the merge computation system in accordance with aspects of the present invention.

FIG. 6 shows an example of a second partition of the merge computation system in accordance with aspects of the present invention.

FIG. 7 shows a timeline of the merge computation system in accordance with aspects of the present invention.

FIG. 8 shows a flowchart of an exemplary method of the merge computation system in accordance with aspects of the present invention.

FIG. 9 shows another flowchart of an exemplary method of the merge computation system in accordance with aspects of the present invention.

### DETAILED DESCRIPTION

Aspects of the present invention relate generally to merge-based computation and, more particularly, to systems and methods of merge-based computation to create a final index for documents in vector databases. Aspects of the present invention minimize a rate for merging documents in a vector database in response to an update or delete operation being performed for at least one document in the vector database. In particular, embodiments of the present invention simplify the code used in updating the vector database in response to a document being changed within the vector database. Aspects of the present invention also improve parallelism during re-computation of the vector database in comparison to the complex process of using a mapping approach using identified chunks within documents of the vector database. Embodiments of the present invention also improve generative artificial intelligence (AI) searching of the vector databases by minimizing the rate for merging documents within the vector database. In particular, aspects of the present invention improve a retrieval augmented generation (RAG) method that is used in providing an accurate response to AI queries.

According to more specific aspects of the invention, the computer-implemented method includes: sorting documents in an increasing order of frequency updates for placement in a vector database; generating multiple recursive partitions of the sorted documents; identify a lowest cost partition from the generated multiple recursive partitions; and merge the documents based on the identified lowest cost partition.

Accordingly, implementations of the present invention provide an improvement in the technical field of merging documents within a vector database. In further embodiments, embodiments of the present invention minimize a rate for performing merging of documents within the vector database. Further, aspects of the present invention simplify the code used to perform merging of the documents within the vector database. Embodiments of the present invention also improve parallelism during merging of the documents within the vector database. In contrast, known systems require an external mapping between a name of a document chunk and a respective identification. In particular, known systems require additional code to implement introspection of the vector database and regeneration of the mapping in response to any loss of the external mapping. Further, known systems are not able to address external databases or indexes being incorporated in the vector database for querying. Accordingly, known systems and methods require additional steps of splitting documents into multiple chunks and then either mapping the chunks to a respective identification or creating chunkified embeddings from chunkified documents which then have to be merged into a final vector database. In contrast, embodiments of the present invention bypass splitting of documents into multiple chunks by minimizing the rate for performing merging of the documents within the vector database.

Implementations of the present invention are thus necessarily rooted in computer technology. For example, the steps of sorting documents by increasing order of frequency updates, creating multiple recursive partitions of the sorted documents using at least one of a Monte Carlo algorithm or simulated annealing, computing a cost of each partition of the multiple recursive partitions, identifying a lowest cost partition of the multiple recursive partitions, and merging the documents into a final vector database based on the identified lowest cost partition are computer-based and cannot be performed in the human mind. For example, creating multiple recursive partitions using at least one of a Monte Carlo algorithm or simulated annealing is, by definition, performed by a computer and cannot practically be performed in the human mind (or with pen and paper) due to the complexity and massive amounts of calculations involved. Given the scale and complexity of creating multiple recursive partitions using at least one of a Monte Carlo algorithm or simulated annealing, it is simply not possible for the human mind, or for a person using pen and paper, to perform the number of calculations involved in creating multiple recursive partitions in real-time, amongst other features described herein that are also root in computer technology.

It should be understood that, to the extent implementations of the invention collect, store, or employ personal information provided by, or obtained from, individuals (for example, users associated with service tickets), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

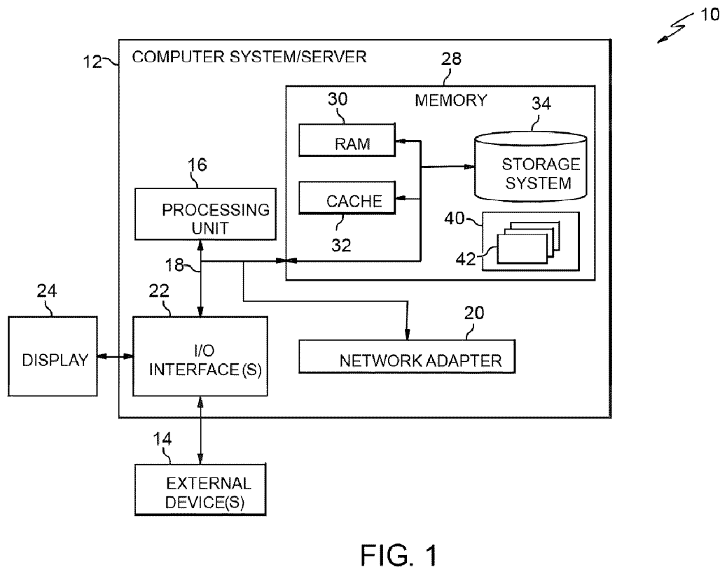

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

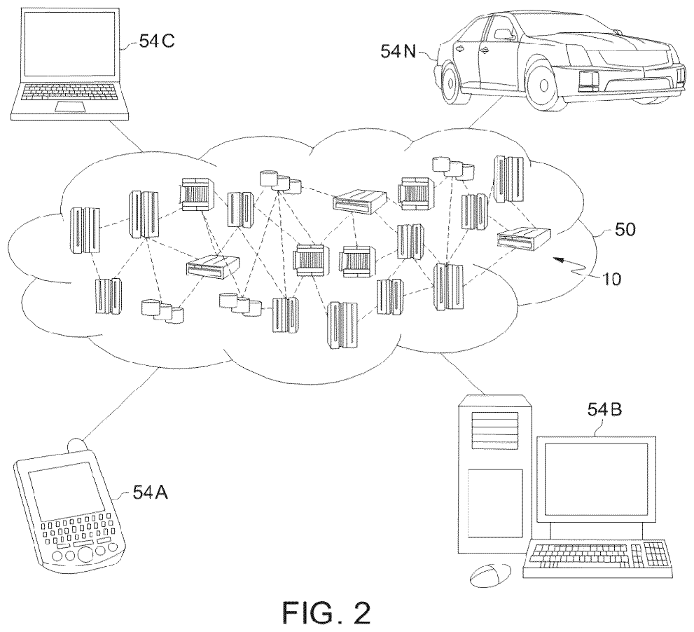

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

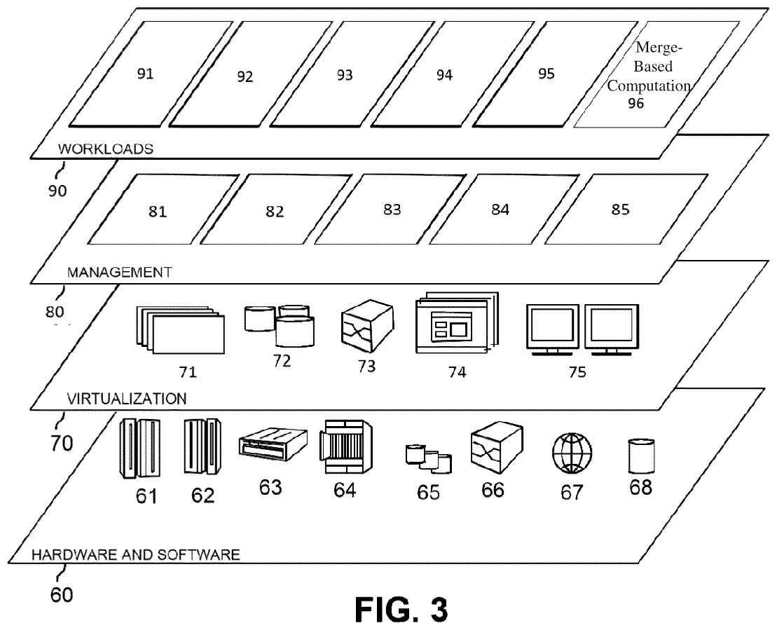

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and merge-based computation 96.

Implementations of the invention may include a computer system/server 12 of FIG. 1 in which one or more of the program modules 42 are configured to perform (or cause the computer system/server 12 to perform) one of more functions of the merge-based computation 96 of FIG. 3. For example, the one or more of the program modules 42 of the merge-based computation 96 may be configured to: sort documents by increasing order of frequency updates, create multiple recursive partitions of the sorted documents using at least one of a Monte Carlo algorithm or simulated annealing, compute a cost of each partition of the multiple recursive partitions, identify a lowest cost partition of the multiple recursive partitions, and merge the documents into a final vector database based on the identified lowest cost partition. In particular, the cost of each partition corresponds with a number of operations that need to be performed to merge documents.

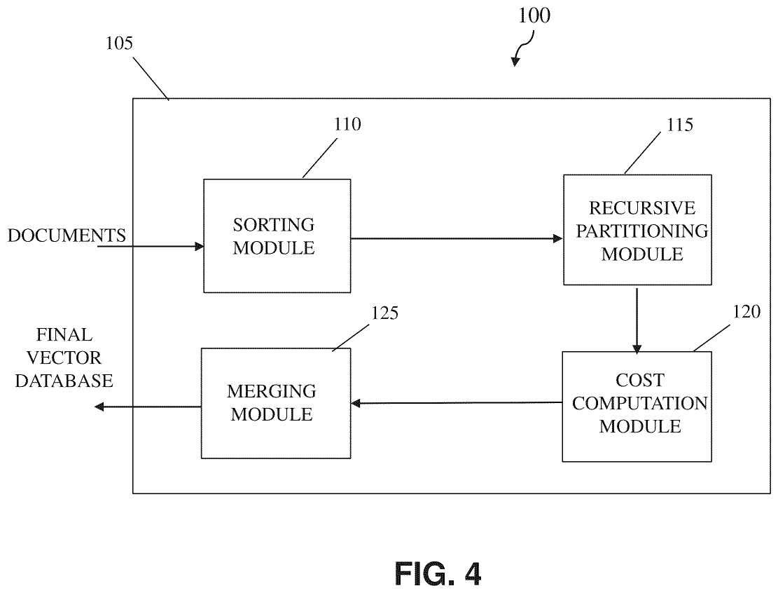

FIG. 4 shows a block diagram of a merge computation system in accordance with aspects of the invention. In embodiments, the merge computation system 100 comprises a merge computation environment 105 which includes a sorting module 110, a recursive partitioning module 115, a cost computation module 120, and a merging module 125, each of which may comprise one or more program modules such as program modules 42 described with respect to FIG. 1 and the merge-based computation 96.

The merge computation system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the sorting module 110 receives a plurality of documents for indexing into a vector database system and sorts the plurality of documents in an increasing order of past frequency updates. For example, the plurality of documents includes document_1, document_2, . . . , document_k, in which k is an integer which represents the last document of the plurality of documents. Therefore, the sorting module 110 sorts the plurality of documents such that the sorted documents S=(document_with_lowest_frequency f1, document_with_second_lowest_frequency f2, . . . , document_with_highest_frequency fk), in which fk corresponds to a highest frequency of a document in the plurality of documents). The sorting module 110 then outputs the sorted documents S to the recursive partitioning module 115.

In FIG. 4, the recursive partitioning module 115 receives the sorted documents S and creates multiple recursive partitions P of the sorted documents S. In embodiments, the recursive partitioning module 115 creates multiple recursive partitions using at least one of a Monte Carlo algorithm or simulated annealing. For example, the recursive portioning module 115 creates a first partition p_1 in the sorted documents S when k=10:

$$p\_ 1 = [ [ [ f 1 , f 2 , f 3 ] , [ f 4 , f 5 ] ] , [ f 6 , f 7 , f 8 ] , [ f 9 , f 10 ] ] . \qquad ( first partition )$$

In the first partition p_1 above, the recursive partitioning module 115 creates a database for a sequence of documents being surrounded by square brackets (e.g., [f1,f2,f3]) and maintains the database for merging with the rest of the documents outside of this grouping in the first partition p_1 (e.g., f4, f5, f6, f7, f8, f9, and f10). The recursive partitioning module 115 may repeat the process for other sequences of documents being surrounded by square brackets in the first partition p_1.

In another example of FIG. 4, the recursive partitioning module 115 creates a second partition p_2 in the sorted documents S when k=10:

$$\begin{matrix}p\_ \text{} 2 = \\ [ [ [ f 1 , f 2 ] , [ f 3 , f 4 , f 5 ] ] , [ f 6 , f 7 , f 8 ] , [ f 9 , f 10 ] ] .\end{matrix} \qquad ( second partition )$$

In the second partition above, the recursive partitioning module 115 creates another database for the sequence of documents being surrounded by square brackets (e.g., [f1,f2]) and maintains the database for merging with the rest of the documents outside of this grouping in the second partition p_2 (e.g., f3, f4, f5, f6, f7, f8, f9, and f10). The recursive partitioning module 115 then repeats the process for other sequences of documents being surrounded by square brackets in the first partition p_2.

The recursive partitioning module 115 may repeat the process above with respect to partitions p_1, p_2 for remaining partitions of the multiple recursive partitions P. Accordingly, the recursive partitioning module 115 creates the multiple recursive partitions P as shown below when k=10:

$$P = \{ p\_ 1 , p\_ 2 , … . \} . \qquad ( multiple recursive partitions )$$

Still referring to FIG. 4, the recursive partitioning module 115 sends the multiple recursive partitions P to a cost computation module 120. The cost computation module 120 receives the multiple recursive partitions P and computes a cost of each partition in the multiple recursive partitions P. For example, the cost of the first partition is shown below:

$$c ( p\_ 1 ) = 5 for f 1 , \text{} f \text{} 2 , \text{} f 3 + 4 for f 4 , \text{} f 5 + 4 + f 6 , \text{} f 7 , f 8 + 3 for f 9 , f 10 = 16 operations . \qquad ( cost of first partition )$$

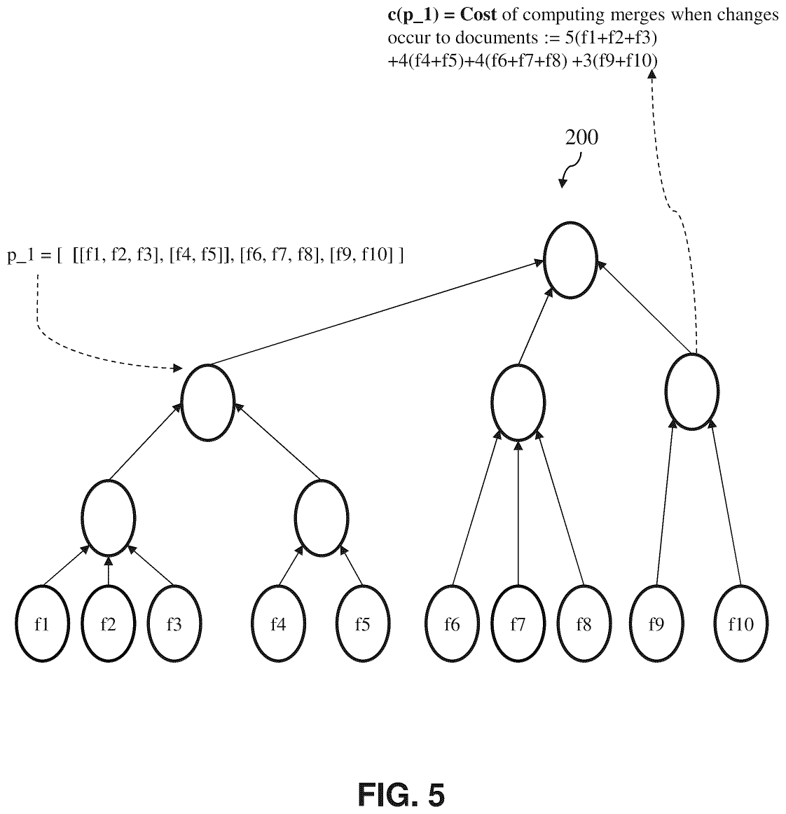

As shown above, the total cost of the first partition c(p_1) is 16 operations. In particular, there are five operations for f1, f2, and f3, 4 operations for f4, f5, four operations for f6, f7, and f8, and three operations for f9, f10. Details of both the first partition p_1 and the total cost of the first partition c(p_1) will be described in detail in FIG. 5.

In another example of FIG. 4, the cost of the second partition is shown below:

$$c ( p\_ 2 ) = 4 for f 1 , \text{} f 2 + 5 for f 3 , \text{} f 4 , \text{} f 5 + 4 for f 6 , \text{} f \text{} 7 , \text{} f 8 + 3 for f 9 , \text{} f 10 = 16 operations . \qquad ( cost of second partition )$$

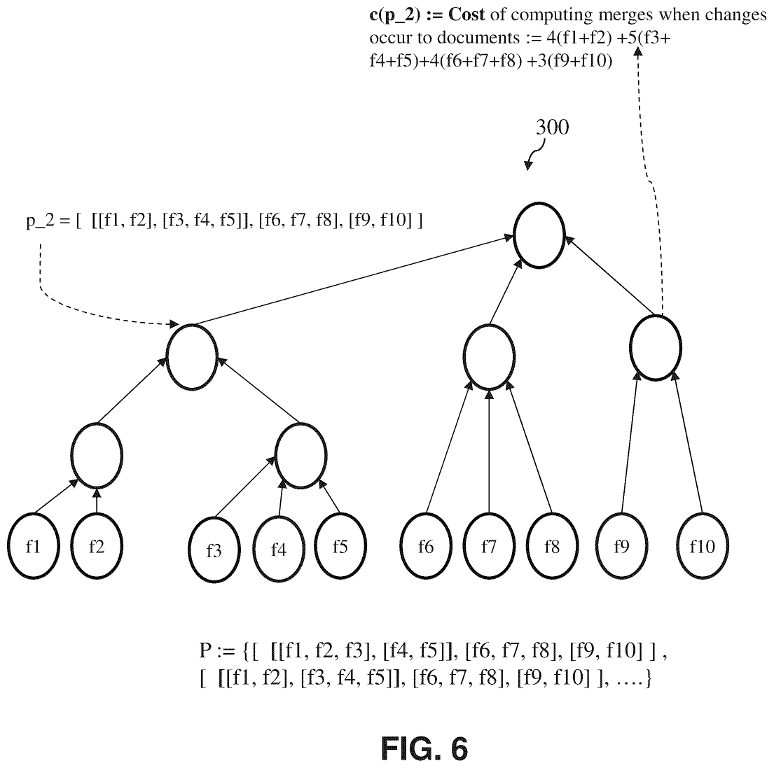

As shown above, the total cost of the second partition c(p_2) is 16 operations. In particular, there are four operations for f1, f2, five operations for f3, f4, and f5, four operations for f6, f7, and f8, and three operations for f9, f10. Details of both the second partition p_2 and the total cost of the second partition c(p_2) will be described in detail in FIG. 6.

The cost computation module 120 then repeats the process above with respect to the cost of the partitions c(p_1), c(p_2) for remaining partitions of the multiple recursive partitions P. The cost computation module 120 chooses a partition p_small with a smallest cost c(p)_small and then sends the partition p_small with the smallest cost c(p)_small to the merging module 125.

In FIG. 4, the merging module 125 implements the merging of the plurality of documents using the partition p_small with the smallest cost c(p)_small. The merging module 125 creates a final vector database with a result of the merging of the plurality of documents and outputs the final vector database to the vector database system. In comparison to known systems, aspects of the present invention reduce a total cost by merging the plurality of documents in a more efficient manner using a smallest cost partition. Further, embodiments of the present invention reduce an overhead of re-calculating costs in comparison to known systems.

FIG. 5 shows an example of the first partition of the merge computation system in accordance with aspects of the present invention. In FIG. 5, a diagram 200 is shown which corresponds with the first partition p_1 shown below:

$$p\_ 1 = [ [ [ f 1 , f 2 , f 3 ] , [ f 4 , f 5 ] ] , [ f 6 , f 7 , f 8 ] , [ f 9 , f 10 ] ] . \qquad ( first partition )$$

In the diagram 200 for FIG. 5, there are two operations for [f1,f2,f3], one additional operation for combining [f1,f2,f3] with [f4,f5], and then two additional operations for [[f1,f2,f3], [f4,f5]] combined with [f6,f7,f8] and [f9, f10]. Thus, the total operations for [f1,f2,f3] is five operations. Further, in the diagram 200, there is one operation for [f4,f5], one additional operation for combining [f4,f5] with [f1,f2,f3], and then two additional operations for [[f4,f5], [f1,f2,f3]] combined with [f6,f7,f8] and [f9, f10]. Thus, the total operations for [f4,f5] is 4 operations.

Still referring to FIG. 5, there are two operations for [f6,f7,f8], one additional operation for [f6,f7,f8] combined with [f9,f10], and then one additional operation for [f6,f7,f8] combined with [f9,f10] combined with [[f4,f5], [f1,f2,f3]]. Thus, the total operations for [f6,f7,f8] is four operations. Further, in the diagram 200, there is one operation for [f9,f10], one additional operation for [f9, f10]] and [f6,f7,f8], and then one additional operation for [f9, f10]] combined with [f6,f7,f8] combined with [[f4,f5], [f1,f2,f3]]. Thus, the total operations for [f9,f10] is three operations. In view of the above, the total cost of the first partition is shown below:

$$c ( p\_ 1 ) = 5 for f 1 , \text{} f \text{} 2 , \text{} f 3 + 4 for f 4 , \text{} f 5 + 4 + f 6 , \text{} f 7 , f 8 + 3 for f 9 , f 10 = 16 operations . \qquad ( cost of first partition )$$

FIG. 6 shows an example of the second partition of the merge computation system in accordance with aspects of the present invention. In FIG. 6, a diagram 300 is shown which corresponds with the second partition p_2 shown below:

$$\begin{matrix}p\_ \text{} 2 = \\ [ [ [ f 1 , f 2 ] , [ f 3 , f 4 , f 5 ] ] , [ f 6 , f 7 , f 8 ] , [ f 9 , f 10 ] ] .\end{matrix} \qquad ( second partition )$$

In the diagram 300 for FIG. 6, there is one operation for [f1,f2], two additional operations for combining [f1,f2] with [f3,f4,f5], and then one additional operation for [[f1,f2], [f3, f4,f5]] combined with [f6,f7,f8] and [f9, f10]. Thus, the total operations for [f1,f2] is four operations. Further, in the diagram 200, there is two operations for [f3,f4,f5], one additional operation for combining [f3, f4,f5] with [f1,f2], and then two additional operations for [[f3,f4,f5], [f1,f2]] combined with [f6,f7,f8] and [f9, f10]. Thus, the total operations for [f3, f4,f5] is five operations.

Still referring to FIG. 6, there are two operations for [f6,f7,f8], one additional operation for [f6,f7,f8] combined with [f9,f10], and one additional operation for [f6,f7,f8] combined with [f9,f10] combined with [[f3,f4,f5], [f1,f2]]. Thus, the total operations for [f6,f7, f8] is four operations. Further, in the diagram 300, there is one operation for [f9,f10], one additional operation for [f9, f10]] and [f6,f7,f8], and then one additional operation for [f9, f10] combined with [f6,f7,f8] combined with [[f3,f4,f5], [f1,f2]]. Thus, the total operations for [f9,f10] is three operations. In view of the above, the cost of the second partition is shown below:

$$c ( p\_ 2 ) = 4 for f 1 , \text{} f 2 + 5 for f 3 , \text{} f 4 , \text{} f 5 + 4 for f 6 , \text{} f \text{} 7 , \text{} f 8 + 3 for f 9 , \text{} f 10 = 16 operations . \qquad ( cost of second partition )$$

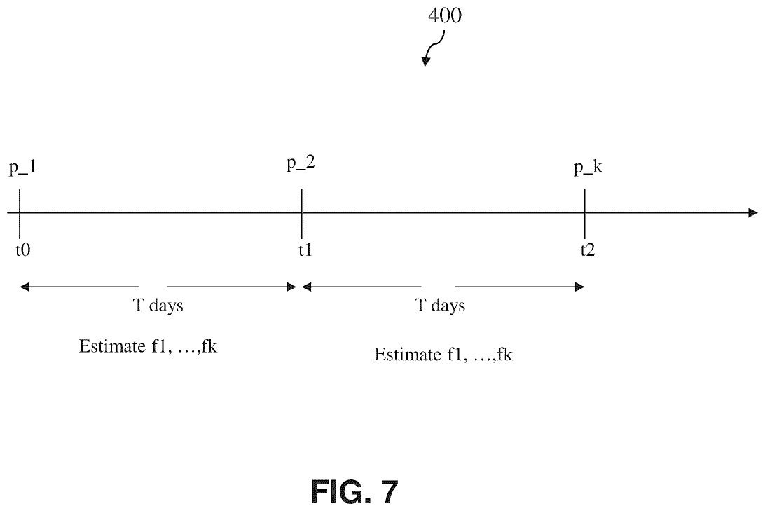

FIG. 7 shows a timeline of the merge computation system in accordance with aspects of the present invention. In FIG. 7, the timeline 400 shows that a time to, the merge computation system 100 determines a partition p_1 and estimates f1, . . . , fk. Further, after T days, at a time t1, the merge computation system 100 determines a partition p_2 and again estimates f1, . . . , fk due to a change in an update frequency (e.g., f_i) of the partitions. After another T days, at a time t2, the merge computation system determines a partition p_k and also estimates f1, . . . , fk due to another change in the update frequency of the partitions. As shown in FIG. 7, the merge computation system 10 re-calculates the partitions and the cost of partitions over time due to changing of the update frequency of the partitions.

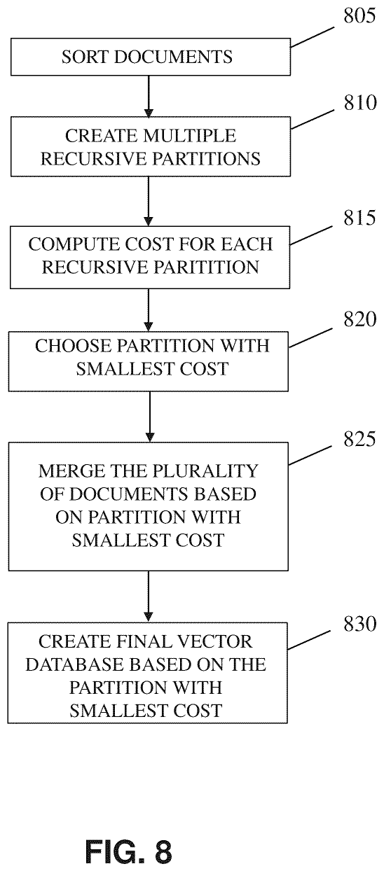

FIG. 8 shows a flowchart of an exemplary method of the merge computation system in accordance with aspects of the present invention. Steps of the method may be carried out in the environment of FIG. 4.

At step 805, the system receives a plurality of documents for indexing into a vector database system. In embodiments and as described with respect to FIG. 4, the sorting module 110 sorts the plurality of documents in an increasing order of past frequency updates and sends the sorted documents to the recursive partitioning module 115.

At step 810, the system creates, at the recursive partitioning module 115, multiple recursive partitions of the sorted documents. In embodiments, and as described with respect to FIG. 4, the recursive partitioning module 115 creates the multiple recursive partitions using at least one of a Monte Carlo algorithm or simulated annealing. In further embodiments, and as described with respect to FIG. 4, the recursive partitioning module 115 sends the multiple recursive partitions to the cost computation module 120.

At step 815, the system computes, at the cost computation module 120, a cost of each partition in the multiple recursive partitions. At step 820, the system chooses, at the cost computation module 120, a partition with a smallest cost. In embodiments, and as described with respect to FIG. 4, the cost computation module 120 sends the partition with the smallest cost to the merging module 125.

At step 825, the system merges, by the merging module 125, the plurality of documents based on the partition with the smallest cost. At step 830, the system creates, at the merging module 125, a final vector database with the merged plurality of documents based on the partition with the smallest cost. In embodiments, and as described with respect to FIG. 4, the merging module 125 sends the final vector database to the vector database system.

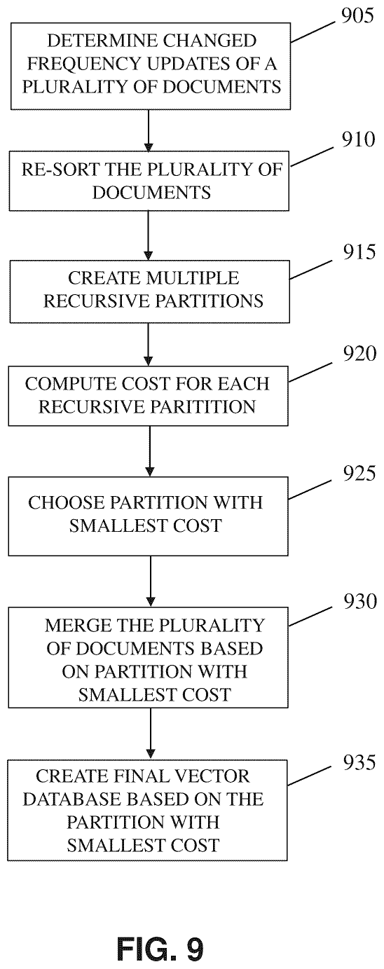

FIG. 9 shows a flowchart of an exemplary method of the merge computation system in accordance with aspects of the present invention. Steps of the method may be carried out in the environment of FIG. 4.

At step 905, the system determines that the plurality of documents have changed frequency updates. In embodiments, and as described with respect to FIG. 4, the sorting module 110 determines that the plurality of documents have changed frequency updates based on database operations such as an update operation or a delete operation. At step 910, the sorting module 110 re-sorts the plurality of documents in an increasing order of past frequency updates based on the changed frequency updates of the plurality of documents and sends the sorted documents to the recursive partitioning module 115.

At step 915, the system creates, at the recursive partitioning module 115, multiple recursive partitions of the sorted documents. In embodiments, and as described with respect to FIG. 4, the recursive partitioning module 115 creates the multiple recursive partitions using at least one of a Monte Carlo algorithm or simulated annealing. In further embodiments, and as described with respect to FIG. 4, the recursive partitioning module 115 sends the multiple recursive partitions to the cost computation module 120.

At step 920, the system computes, at the cost computation module 120, a cost of each partition in the multiple recursive partitions. At step 925, the system chooses, at the cost computation module 120, a partition with a smallest cost. In embodiments, and as described with respect to FIG. 4, the cost computation module 120 sends the partition with the smallest cost to the merging module 125.

At step 930, the system merges, by the merging module 125, the plurality of documents based on the partition with the smallest cost. At step 935, the system creates, at the merging module 125, a final vector database with the merged plurality of documents based on the partition with the smallest cost. In embodiments, and as described with respect to FIG. 4, the merging module 125 sends the final vector database to the vector database system.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
sorting, by a computing device, a plurality of documents in an increasing order of frequency updates comprising database operations including at least one of an update database operation or a delete database operation;
creating, by the computing device, multiple recursive partitions of the plurality of sorted documents;
computing, by the computing device, a cost of the multiple recursive partitions;
choosing, by the computing device, a partition with a smallest cost from computed costs of the multiple recursive partitions; and
merging, by the computing device, the plurality of documents based on the partition with the smallest cost.

2. The method of claim 1, wherein the creating the multiple recursive partitions of the sorted documents occurs based on a Monte Carlo algorithm.

3. The method of claim 1, wherein the creating the multiple recursive partitions of the sorted documents occurs based on simulated annealing.

4. The method of claim 1, further comprising:
receiving, by the computing device, the plurality of documents for indexing into a vector database system; and
performing, by the computing device, generative artificial intelligence (AI) searching by utilizing the merged plurality of documents based on the partition with the smallest cost.

5. The method of claim 1, wherein the increasing the order of frequency updates comprises a first document comprising a first historical frequency update in a first position, a second document comprising a second historical frequency update which has a greater frequency than the first historical frequency update in a second position, a third document comprising a third historical frequency update which has the greater frequency than the second historical update in a third position, and a fourth document comprising a fourth historical frequency update which has the greater frequency than the third historical update in a fourth position.

6. The method of claim 1, wherein the cost of the multiple recursive partitions represents a cost in an order of the total number of operations to merge the plurality of documents, and the merging of the plurality of documents minimizes a rate for merging the plurality of documents within a vector database system.

7. The method of claim 1, wherein the multiple recursive partitions comprise a sequence of documents with a database that is maintained for merging with remaining documents of the plurality of documents.

8. The method of claim 1, further comprising determining, by the computing device, a change in a frequency of the frequency updates of the plurality of documents.

9. The method of claim 8, further comprising:
re-sorting, by the computing device, the plurality of documents in the increasing order of frequency updates based on the change in a frequency of the frequency updates of the plurality of documents; and
creating, by the computing device, another set of multiple recursive partitions of the re-sorted documents.

10. The method of claim 9, further comprising computing, by the computing device, a cost of the another set of multiple recursive partitions.

11. The method of claim 10, further comprising:
choosing, by the computing device, another partition with a smallest cost from computed costs of the another set of multiple recursive partitions; and
merging, by the computing device, the plurality of documents based on the another partition with the smallest cost.

12. A computer program product comprising one or more computer readable storage media having program instructions collectively stored on the one or more computer readable storage media, the program instructions executable to:
receive a plurality of documents for indexing into a vector database system;
sort the plurality of documents in an increasing order of frequency updates comprising database operations including at least one of an update database operation or a delete database operation;
create multiple recursive partitions of the plurality of sorted documents;
compute a cost of the multiple recursive partitions;
choose a partition with a smallest cost from computed costs of the multiple recursive partitions;
merge the plurality of documents based on the partition with the smallest cost; and
create a final vector database which comprises the merged plurality of documents.

13. The computer program product of claim 12, wherein the creating the multiple recursive partitions of the sorted documents occurs based on a Monte Carlo algorithm.

14. The computer program product of claim 12, wherein the creating the multiple recursive partitions of the sorted documents occurs based on simulated annealing.

15. The computer program product of claim 12, wherein the increasing the order of frequency updates comprises a first document comprising a first historical frequency update in a first position, a second document comprising a second historical frequency update which has a greater frequency than the first historical frequency update in a second position, a third document comprising a third historical frequency update which has the greater frequency than the second historical update in a third position, and a fourth document comprising a fourth historical frequency update which has the greater frequency than the third historical update in a fourth position.

16. The computer program product of claim 12, wherein the cost of the multiple recursive partitions represents a cost in an order of the total number of operations to merge the plurality of documents.

17. The computer program product of claim 12, wherein the multiple recursive partitions comprise a sequence of documents with a database that is maintained for merging with remaining documents of the plurality of documents.

18. The computer program product of claim 12, further comprising:
perform generative artificial intelligence (AI) searching by utilizing the merged plurality of documents based on the partition with the smallest cost;
determine a change in a frequency of the frequency updates of the plurality of documents;
re-sort the plurality of documents in the increasing order of frequency updates based on the change in the frequency of the frequency updates of the plurality of documents;
create another set of multiple recursive partitions of the re-sorted documents; and
compute a cost of the another set of multiple recursive partitions.

19. The computer program product of claim 18, further comprising:
choose another partition with a smallest cost from computed costs of the another set of multiple recursive partitions; and
merge the plurality of documents based on the another partition with the smallest cost,
wherein the merging of the plurality of documents minimizes a rate for merging the plurality of documents within the vector database system.

20. A system comprising:
a processor, a computer readable memory, one or more computer readable storage media, and program instructions collectively stored on the one or more computer readable storage media, the program instructions executable to:
receive a plurality of documents for indexing into a vector database system;
sort the plurality of documents in an increasing order of frequency updates comprising database operations including at least one of an update database operation or a delete database operation;
create multiple recursive partitions of the plurality of sorted documents based on a Monte Carlo algorithm;
compute a cost of the multiple recursive partitions;
choose a partition with a smallest cost from computed costs of the multiple recursive partitions;
merge the plurality of documents based on the partition with the smallest cost; and
create a final vector database which comprises the merged plurality of documents.
